(19) United States
(12) Patent Application Publication
(10) Pub. No.: US 2002/0092130 A1
(43) Pub. Date: Jul. 18, 2002

(54) Hinge structure of adjustable arm

(76) Inventors: Kou-Lung Tseng, Chu Pei City (TW); Wolf Wang, Chu Pei City (TW)

Correspondence Address: Trademark & Patent Counselors of America, P.C., 915 Broadway, New York, NY, 10010-7108, US

(21) Appl. No.: 09/904,879

(22) Filed: Jul. 12, 2001

(30) Foreign Application Priority Data
Jan. 16, 2001 (TW) 090200828

(51) Int. Cl. E05D 11/08

(52) U.S. Cl. 16/342

(57) ABSTRACT

A hinge structure of an adjustable arm used in a document camera is provided, and the adjustable arm is capable of performing a pivotal movement on a base. The hinge structure includes a hinge device for articulating the adjustable arm and having an extended portion, a spacer mounted on the extended portion of the hinge device for providing a cushioning effect, a fastening device mounted on the hinge device for fastening the hinge device, and an elastic device mounted between the spacer and the fastening device for adjusting the hinge device, thereby compensating the pivotal movement of the adjustable arm.

### FIELD OF THE INVENTION

The present invention relates to a hinge structure of an adjustable arm, and more particularly to a hinge structure of an adjustable arm used in a document camera for performing a pivotal movement on a base.

### BACKGROUND OF THE INVENTION

Generally, a document camera is adapted to the peripheral apparatus of a conventional liquid crystal overhead projector. FIG. 1 is a schematic view showing a conventional document camera having an adjustable arm 11 connected to a base 13 by a hinge 12. FIG. 2 is a schematic view showing the elements of the hinge 12 in FIG. 1. A pivot shaft 14 is disposed on the adjustable arm 11 and is fastened to an inner sleeve 15, which is fastened by an outer sleeve 16 by a screw 17, as shown in FIG. 3.

An included angle D between the adjustable arm 11 and the base 13 is adjusted when the document camera is used. A screw 17 is loosed and then is fastened after obtaining the proper included angle. The foregoing operation is very inconvenient. In addition, the screw 17 is easily abraded when the screw 17 is frequently loosing and fastened. Consequently, the outer sleeve 16 will be incapable of being fastened tightly and the quality and the reliability of the document camera would be controlled with difficulty.

It is therefore tried by the applicant to deal with the above situation encountered in the prior art.

### SUMMARY OF THE INVENTION

It is therefore an object of the present invention to provide a hinge structure of the adjustable arm used in a document camera, in which the adjustable arm is capable of performing a pivotal movement on a base.

It is another object of the present invention to provide the hinge structure of the adjustable arm adjusted by using an elastic device

It is another object of the present invention to provide the hinge structure of the adjustable arm for compensating the pivotal movement of the adjustable arm by using a spring of an outer sleeve.

It is another object of the present invention to provide the hinge structure of the adjustable arm for preventing the spring from being sprung by using a broad screw nut on the screw.

According to an aspect of the present invention, the hinge structure of the adjustable arm is used in a document camera, wherein the adjustable arm is capable of performing a pivotal movement on a base. The hinge structure of the adjustable arm includes a hinge device for articulating the adjustable arm and having an extended portion, a spacer mounted on the extended portion of the hinge device for providing a cushioning effect, a fastening device mounted on the hinge device for fastening the hinge device, and an elastic device mounted between the spacer and the fastening device for adjusting the hinge device, thereby compensating the pivotal movement of the adjustable arm.

Preferably, the hinge device further includes a pivot shaft disposed on the adjustable arm for pivoting the adjustable arm, an inner sleeve fastened on the pivot shaft, and an outer sleeve fastened on the inner sleeve and integrally formed with the extended portion of the hinge device for holding the inner sleeve to rotate inside the outer sleeve.

Preferably, the elastic device is a spring for compensating the pivotal movement of the adjustable arm by expanding the outer sleeve.

Preferably, the fastening device is a screw for fastening the inner sleeve, the outer sleeve and the elastic device.

Preferably, the screw further includes a broad screw nut for preventing the spring from being sprung when the screw is fastened.

Preferably, the spacer further includes a flange for positioning the spacer on the extended portion of the hinge device.

According to another aspect of the present invention, the pivot structure of an adjustable arm used in a document camera, wherein the adjustable arm is capable of performing a pivotal movement on a base. The pivot structure of the adjustable arm includes a hinge device for articulating the adjustable arm and having an extended portion, a fastening device mounted on the hinge device for fastening the hinge device, and an elastic device mounted between the hinge device and the fastening device for adjusting the hinge device, thereby compensating the pivotal movement of the adjustable arm.

Preferably, the pivot structure of the adjustable arm further includes a spacer mounted on the extended portion of the hinge device for providing a cushioning effect between the hinge device and the elastic device.

The present invention may best be understood through the following descriptions with reference to the accompanying drawings, in which:

### BRIEF DESCRIPTION OF THE DRAWINGS

FIG. 1 is a schematic view showing a document camera according to the prior art;

FIG. 2 is a schematic view showing the elements of the hinge in FIG. 1;

FIG. 3 is a schematic view showing the assembly of the hinge shown in FIG. 2;

FIG. 4 is a schematic view showing a hinge structure of an adjustable arm used in a document camera according to a preferred embodiment of the present invention;

FIG. 5 is a schematic view showing the elements of the hinge structure shown in FIG. 4; and

FIG. 6 is a schematic view showing the assembly of the hinge structure shown in FIG. 5.

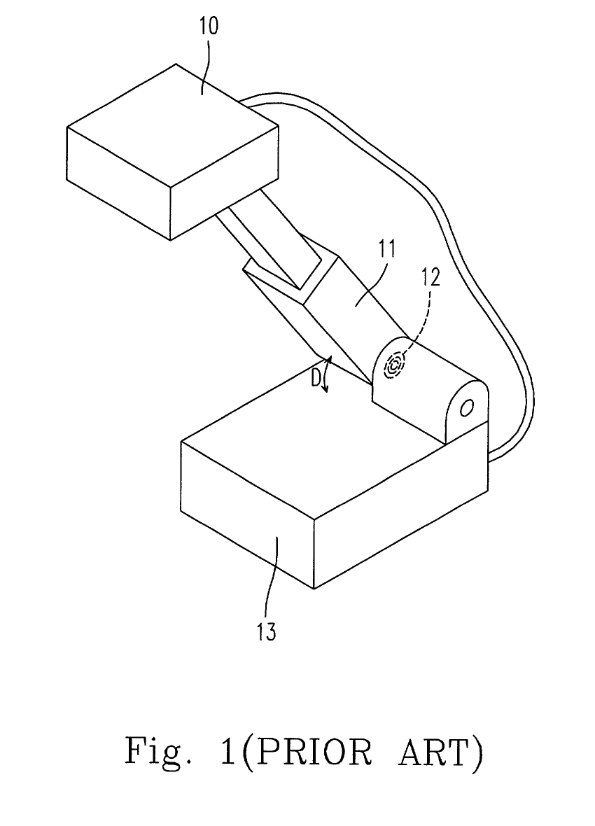

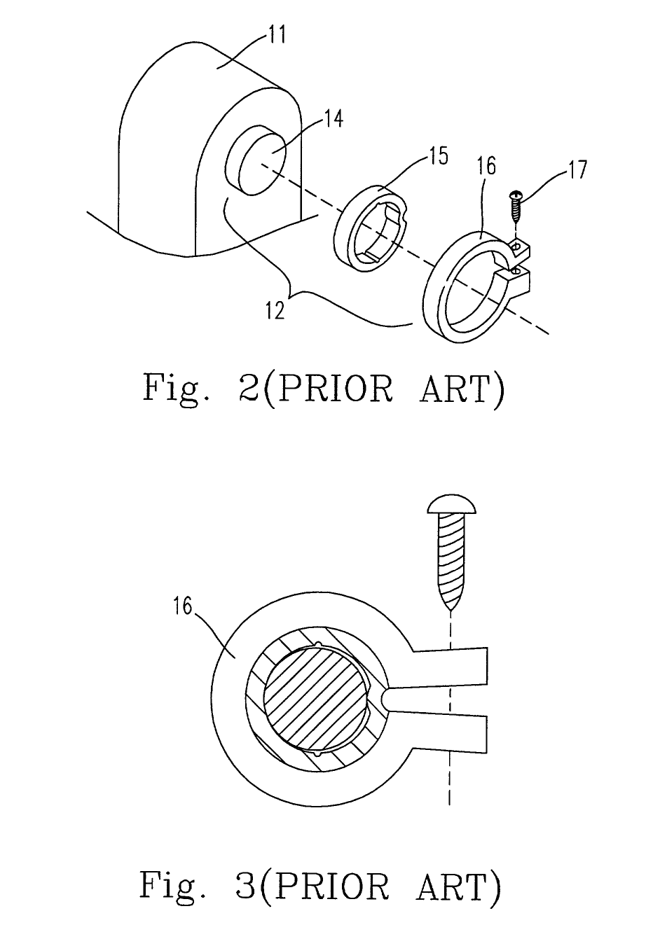

### DETAILED DESCRIPTION OF THE PREFERRED EMBODIMENTS

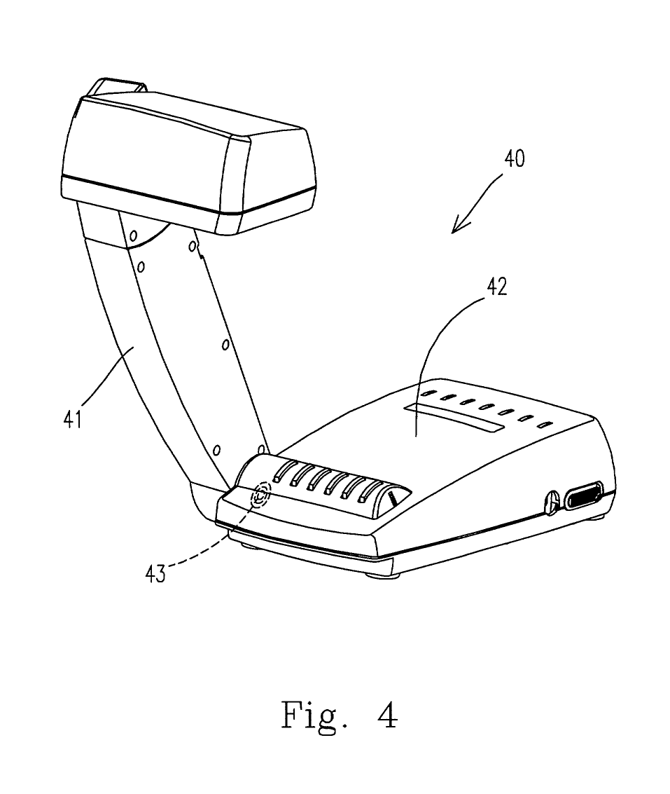

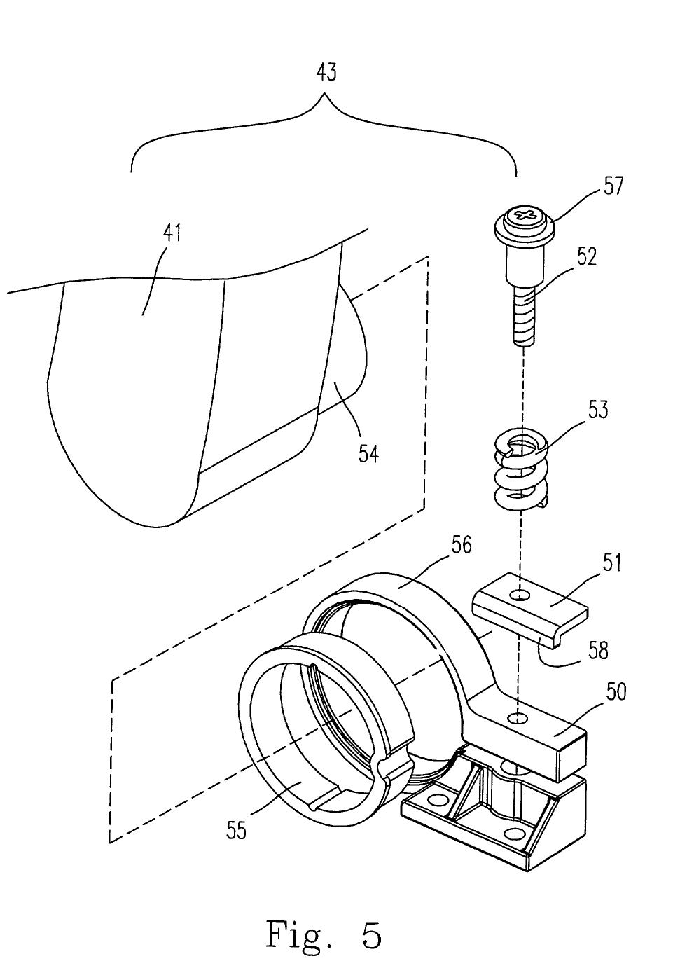

FIGS. 4 and 5 are schematic views showing a hinge structure of an adjustable arm according to a preferred embodiment of the present invention. The hinge structure of the adjustable arm 41 is used in a document camera 40, and the adjustable arm 41 is capable of performing a pivotal movement on a base 42. The hinge structure of the adjustable arm includes a hinge device 43, a spacer 51, a fastening device 52 and an elastic device 53. The hinge device 43 could articulate the adjustable arm 41 and have an extended portion 50 shown in FIG. 5. The spacer 51 is mounted on the extended portion 50 of the hinge device 43 for providing a cushioning effect. The fastening device 52 is mounted on the hinge device 43 for fastening the hinge device 43. The elastic device 53 is mounted between the spacer 51 and the fastening device 52 for adjusting the hinge device 43, thereby compensating the pivotal movement of the adjustable arm 41.

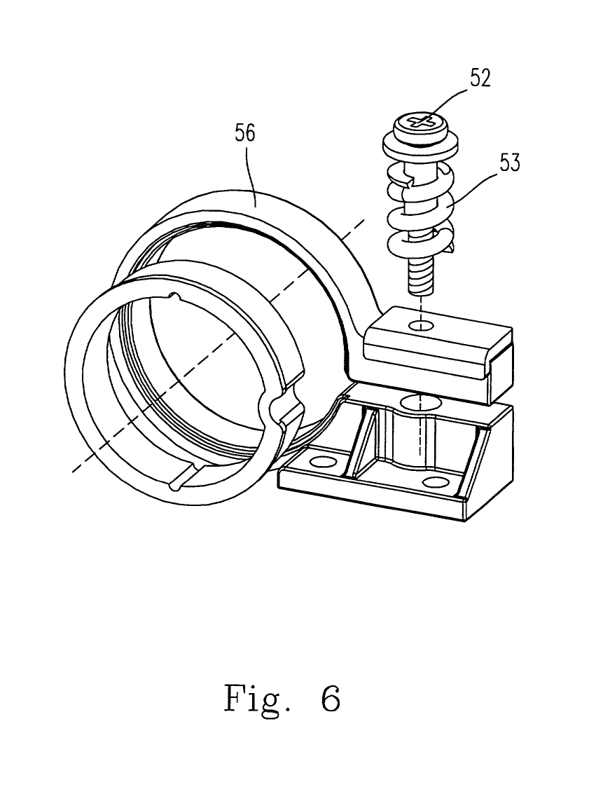

Moreover, the hinge device 43 includes a pivot shaft 54, an inner sleeve 55 and an outer sleeve 53. The pivot shaft 54 is disposed on the adjustable arm 41 for pivoting the adjustable arm 41. The inner sleeve 55 is fastened on the pivot shaft 51. The outer sleeve 56 is fastened on the inner sleeve 55 and integrally formed with the extended portion 50 of the hinge device 43 for holding the inner sleeve 55 to rotate inside the outer sleeve 56. The elastic device 53 is preferably a spring 53 for compensating the pivotal movement in the pivot shaft 54 of the adjustable arm 41 by expanding the outer sleeve 56. The fastening device 52 is preferably a screw 52 for fastening the inner sleeve 55, the outer sleeve 56 and the elastic device 53. The screw 52 further includes a broad screw nut 57 for preventing the spring 53 from being sprung when the screw 52 is fastened. The spacer 51 further includes a flange 57 for being positioned on the extended portion 50 of the hinge device 43. FIG. 6 is a schematic view showing the assembly of the spring 53 and the screw 52 combined with the outer sleeve 56 according to a preferred embodiment of the present invention.

On the other hand, the present invention provides a pivot structure of an adjustable arm used in a document camera 40, and the adjustable arm 41 is capable of performing a pivotal movement on a base 42. The pivot structure of an adjustable arm includes a hinge device 43, a fastening device 52 and an elastic device 53. The hinge device 43 is used for articulating the adjustable arm 41 and has an extended portion 50. The fastening device 52 is mounted on the hinge device 43 for fastening the hinge device 43. The elastic device 53 is mounted between the hinge device 43 and the fastening device 52 for adjusting the hinge device 43, thereby compensating the pivotal movement of the adjustable arm 41. Moreover, the pivot structure of an adjustable arm further includes a spacer 51 mounted on the extended portion 50 of the hinge device 43 for providing a cushioning effect between the hinge device 43 and the elastic device 53.

It is understood that the adjustable arm could efficiently perform a pivotal movement by using the elastic device provided by the present invention. Moreover, the hinge structure of the adjustable arm could compensate the pivotal movement of the adjustable arm by using a spring on the screw. Therefore, the prior art could be improved according to the present invention.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What we claim is:

1. A hinge structure of an adjustable arm used in a document camera, wherein said adjustable arm is capable of performing a pivotal movement on a base, comprising:
a hinge device for articulating said adjustable arm and having an extended portion;
a spacer mounted on said extended portion of said hinge device for providing a cushioning effect;
a fastening device mounted on said hinge device for fastening said hinge device; and
an elastic device mounted between said spacer and said fastening device for adjusting said hinge device, thereby compensating said pivotal movement of said adjustable arm.

2. The hinge structure according to claim 1, wherein said hinge device further comprises:
a pivot shaft disposed on said adjustable arm for pivoting said adjustable arm;
an inner sleeve fastened on said pivot shaft; and
an outer sleeve fastened on said inner sleeve and integrally formed with said extended portion of said hinge device for holding said inner sleeve to be rotate inside said outer sleeve.

3. The hinge structure according to claim 2, wherein said elastic device is a spring for compensating said pivotal movement of said adjustable arm by expanding said outer sleeve.

4. The hinge structure according to claim 2, wherein said fastening device is a screw for fastening said inner sleeve, said outer sleeve and said elastic device.

5. The hinge structure according to claim 4, wherein said screw further comprises a broad screw nut for preventing said spring from being sprung when said screw is fastened.

6. The hinge structure according to claim 2, wherein said spacer further comprises a flange for positioning said spacer on said extended portion of said hinge device.

7. A pivot structure of an adjustable arm used in a document camera, wherein said adjustable arm is capable of performing a pivotal movement on a base, comprising:
a hinge device for articulating said adjustable arm and having an extended portion;
a fastening device mounted on said hinge device for fastening said hinge device; and
an elastic device mounted between said hinge device and said fastening device for adjusting said hinge device, thereby compensating said pivotal movement of said adjustable arm.

8. The pivot structure according to claim 7, further comprising a spacer mounted on said extended portion of said hinge device for providing a cushioning effect between said hinge device and said elastic device.
